(19) United States
(12) Patent Application Publication
(10) Pub. No.: US 2021/0152351 A1
(43) Pub. Date: May 20, 2021

(54) Computer System Implemented Method for Generating a Symmetric Encryption Key Used for Encrypting and Decrypting a Computer System User's Hidden Data

(71) Applicant: Mark Rodney Anson, West End (AU)

(72) Inventor: Mark Rodney Anson, West End (AU)

(21) Appl. No.: 16/844,558

(22) Filed: Apr. 9, 2020

Related U.S. Application Data
(60) Provisional application No. 62/831,385, filed on Apr. 9, 2019.

(51) Int. Cl. H04L 9/08; H04L 9/06; H04L 9/14

(52) U.S. Cl. CPC H04L 9/0869; H04L 9/0643; H04L 2209/38; H04L 9/0631; H04L 9/0637; H04L 9/14

(57) ABSTRACT

Aspects of invention include: methods and apparatus implemented in a computer system, the methods and apparatus producing a symmetric encryption key termed a Cipherkey produced for protecting a computer system user's hidden data from unauthorised access by an intruder. The methods and apparatus receive a first input item being a user supplied Secret, and a second input item termed Encrypted Random Data. A computer system performs a precise method of computation based on this input. Six steps are disclosed that result in a hash value result termed a Cipherkey, a hash value that can be used as a symmetric encryption key for protecting a computer system user's hidden data.

This application claims the benefit of U.S. Provisional Patent Application 62/831,385, filed on Apr. 9, 2019, and incorporated herein by reference.

### FIELD OF INVENTION

Aspects of invention pertain to the field of computer security.

### BACKGROUND

Securing hardware and software against unauthorised attacks has and still remains an ongoing problem. A plurality of different methods and apparatus have developed over the years including the use of symmetric and asymmetric encryption and a range of other encryption protocols. However, despite increasing sophistication of applied cryptography challenges still remain.

### SUMMARY OF ASPECTS OF INVENTION

According to one aspect of the invention, an apparatus and method for use in association with a computer system having a non-transient computer readable medium encoded with computer readable instructions that cause a processor included in the computer system to perform operations for creation of an apparatus for producing a symmetric encryption cipher key for encrypting and decrypting a collection of encryption keys and the computer system user's configuration data, including:

a processor executing an instruction to construct an apparatus for performing cryptographic methods;
the apparatus receiving a secret input item or password;
the apparatus hashing a secret in three different ways using three different hashing algorithms;
the apparatus using a first hash value to find an encrypted random data;
the apparatus using a second hash value to decrypt an encrypted random data;
the apparatus joining a third hash value and decrypted random data together;
the apparatus hashing the joined data to generate a cipher key;
the apparatus ciphering private information with a cipher key.

### Discussion of Broad Inventive Concepts Pertaining to Aspects of the Invention

One aspect of the inventor's broad inventive concepts relates to methods and an apparatus for calculating and using an encryption key in a system using advanced encryption standard (AES) block cipher algorithms, where an AES key is derived from a hash value. Without limitation, while use of AES keys is preferred in order to provide practical security, including checks against tampering, any form of symmetric key of sufficient length to provide practical security can be used in association with the inventor's contribution.

The advanced encryption standard (AES) block cipher algorithm, or AES cipher, is an iterative cipher algorithm supporting different operational modes, including cipher block chaining (CBC), electronic codebook (ECB) and Galois Counter Mode (GCM), with the GCM operation mode being a block cipher mode of operation that uses hashing over a binary Galois field to provide authenticated encryption. The detailed document describing the full features of GCM entitled “The Galois/Counter Mode of Operation (GCM)” can be found in the NIST Special Publication 800-38D.

A hash algorithm is a mathematical algorithm that maps data of arbitrary size, such as a file or a string of text, to a bit string of a fixed size (a hash value), which is designed to be a one-way function, meaning the function is not feasible to invert. A properly constructed hash algorithm is designed to be deterministic—meaning that a given input value such as a block of text must always generate the same hash value. These things are believed to be true of the SHA-2 family of algorithms by persons skilled in the art.

One way to produce a symmetric encryption key is to provide seed input such as a large file or password to a one-way hash algorithm function such as SHA-256 that outputs data of a fixed size, the hash. People skilled in the art will know that a primary feature of cryptographic hash functions is their collision resistance: it should not be possible to find two different input values that result in the same hash output, and again this is true of the SHA-256, SHA-384 and SHA-512 algorithms. It is reasonably expected that in the future, new algorithms will be developed that will also provide the valuable features of SHA-256, SHA-384 and SHA-512 algorithms and also that the future algorithms can also be used in implementations of this disclosed aspect of invention.

A properly constructed hash created by a one-way hash algorithm function will always produce identical output from the same seed input. People skilled in the art will know that a single cryptographic hash value derived from a specific seed input can be used to derive many other cryptographic hash values that can then be used to provide other symmetric encryption keys.

One technique noted by the inventor involves use of a key derivation function using a random number generating function to produce a plurality of random number seeds that, in combination with a cryptographic hash function, can then create a corresponding plurality of secret keys; said cryptographic hash function being applied to a master key, a file, a password, or a passphrase. In a technique researched by the inventor, a randomly generated seed value and a cryptographic hash value are joined into a combined data and then that combined data is hashed to produce a new cryptographic hash value that can be used as an encryption key for encrypting a single data or a file; typically, the randomly generated seed value is then shared or stored together with the encrypted data so as to facilitate the deciphering of the data at a later time. One problem that arises when using this technique that uses a seed input stored along with encrypted data, as identified by the inventor, is that it is possible for a cryptanalyst who can discover the master key to then be able to recreate all the derived encryption keys and to read all the encrypted, stored files.

However, when large random data value seeds are considered, and those randomly generated values known in prior art are not available or accessible, then, even when a master key from which other keys are derived is known the encrypted data still cannot be deciphered. One aspect of the current invention developed by the inventor is a method for producing, encrypting and hiding randomly generated seed values. What is disclosed is a system for producing randomly generated seed data where said data is of great length, is encrypted, and is put in an inaccessible location so the data is unavailable to anyone other than a valid user of a computer system. In one disclosed aspect, an encrypted random seed data can be retained in a file that is stored in a detachable USB mountable device kept in the possession of a user. In another aspect, an encrypted random seed data can be stored in a cloud storage container controlled by a network administrator enforcing policies and restrictions so the data is only released in response to a valid request from a valid user.

A solution to problems identified by the inventor, in disclosed aspects of invention, is provided in methods and an apparatus for managing secret passwords, keys and fresh random cryptographic seeds. Additionally, a solution that produces an apparatus for encrypting a configuration data containing a plurality of asymmetric and symmetric encryption keys and other information, then outputting that as an encrypted private data such that the output can be stored and hidden from anyone other than an authenticated user, is also provided. What is more, a solution is provided to protect a secure network where users are distributing encrypted media and encrypted content to one another. A secure network service provider needs methods for managing users of the network, keeping out intruders, and aspects of the inventor's broad inventive concepts as disclosed in this document provides a method and apparatus for restricting the network access of a specific user and, in particular, to prevent unauthorised persons from trying to gain access to the system. The disclosed aspects of invention provide a secure solution enabling users and network service providers to share encrypted files and data safely.

The disclosed aspects of invention consistent with the inventor's broad inventive concepts provide computer implemented methods and apparatus for producing a symmetric encryption key, which can include an AES-256 symmetric key in one aspect of invention, termed a cipher key (Cipherkey), a key used for encrypting and decrypting a computer user's data in order to hide and protect the data from access by an unauthorised intruder. Eventual secret configuration data decrypted by the symmetric cipher key (Cipherkey) can include an encryption/decryption key set that can either be symmetric or asymmetric together with other sensitive configuration data.

The methods and apparatus provide reception by a computer system of a first input being a user provided password or secret data, which can be inputted directly via a computer user interface. The system can also receive a second input item being a sufficiently long array or stream of random bytes of data, the data being sufficiently long to provide practical security. This random data can be provided in a number of ways, according to different aspects of invention. After receiving the two inputs a one-way hashing algorithm can calculate a hash value termed a cipher key (Cipherkey) which is used as a symmetric encryption key for protecting a user's hidden data, in particular system configuration data. In one aspect, the cipher key (Cipherkey) can be used in AES-GCM mode providing authenticated encryption and decryption, and the IV (initialization vector) and any additional data can be appended or prepended to the bytes of encrypted data output by the AES-GCM procedure: see Definition section below for the definition of the IV (Initialization Vector) and other AES-GCM concepts.

A plurality of aspects of the disclosed invention, consistent with the inventor's broad inventive concepts, provide multiple ways for computing a cipherkey (Cipherkey). Implementations of methods and apparatus described in this document provide a set of secure procedures for creating a cipher key (Cipherkey) and protecting a user's hidden data and in particular a computer system's configuration data.

In a first aspect of invention consistent with the inventor's broad inventive concepts, methods and apparatus provide reception of a user provided secret that is used to compute three hash values, a first hash value, Hash1; a second hash value, Hash2; and a third hash value, Hash3. These three hash values are calculated by hashing a user's secret data using three different one-way hashing algorithms, which can be SHA256, SHA384 and SHA512 according to one aspect of invention or for that matter any other hash algorithms that provide practical security. Methods and apparatus consistent with the inventor's broad inventive concepts can then generate a text string from the Hash2 and use this text string as a search criterion, searching for an encrypted random data file stored by the computer system in data storage. If a matching file is found then the file can be imported and then decrypted using the third hash value, Hash3, as a decryption key. In the next step, the methods and apparatus provide joining of Hash1 and the decrypted random data to produce a cipher key (Cipherkey) source material object. The cipher key (Cipherkey) source material is then hashed, in a final step, to provide a cipher key (Cipherkey) used for encrypting and decrypting a user's hidden data. The hidden data can contain, among other sensitive information, symmetric or asymmetric encryption keys for use in encrypting or decryption user data once the system has been configured.

In disclosed aspects of invention, a decrypted random data can be at least two hundred and fifty-six bits in length (the length of an AES-256 encryption key), but typically thousands of characters in length. However, the random data can be of any length that is consistent with practical security and can typically increase over time, consistent with increases in computing power available to unauthorized intruders into the system. Consequently, it will be simpler for a potential attacker to try to compute all possible keys that might define a specific AES-256 cipher key (Cipherkey) used for encrypting a user's hidden data than to attempt to compute all the possible values that might define the sufficiently large random data objects used as source material for a cipher key (Cipherkey) generated according to disclosed methods and apparatus. With a key length of two hundred and fifty-six bits, AES-256 keys are considered safe to use and infeasible to generate by brute force computing. Advantageously, the sufficiently large random data objects provided in implementations of the disclosed aspects of invention are typically thousands of characters in length, making any attempt to brute force guess a specific random data object a more difficult problem than guessing a specific AES-256 encryption key.

The above aspects of invention create three difficult problems a cryptanalyst or hacker has to solve when they are attempting to create a cipher key (Cipherkey) needed for decrypting a user's hidden data. An attacker has to obtain the encrypted random data object. An attacker has to discover the Hash3 value needed for decrypting the random data object. And an attacker must also discover the required Hash1 value included in the cipher key (Cipherkey) source material that gets hashed to provide a cipher key (Cipherkey). In one aspect Hash1, Hash2 and Hash3 can be automatically generated upon entry of a password. However, in order to provide enhanced security, additional passwords can be required in order to progress through each aspect of the processes described above. For example, a first password could be required to produced Hash1 then a second password could be required to produce Hash2, with similar variations for Hash3.

Accordingly, in a second aspect of invention, methods and apparatus provide reception of a user inputted password that can then be used to calculate two hash values Hash1 and Hash2 by hashing the user's password using two different hashing algorithms that can be SHA384 and SHA512 or for that matter any other two hashing algorithms that provide practical security. The methods and apparatus provide searching for a stored file identified by Hash2 then when the file is found it can be decrypted using Hash1. Differing from the previous first aspect, the methods and apparatus implementing these processes do not make use of a Hash3 value. The decrypted file content is decrypted by Hash1, not Hash3. The decrypted file content provides the required sufficiently long array or stream of random bytes of data required as source material for a cipher key (Cipherkey). That is, in this aspect Hash1 need not be appended to the random data comprising the decrypted file content, the cipher key (Cipherkey) may be generated by hashing only the random data comprising the decrypted file content.

According to a first aspect of invention, the cipher key (Cipherkey) source material is a combined data object formed from the joined Hash1 value and the decrypted random data. Additionally, in first, second and other aspects of invention, the content of the decrypted random data file by itself can be the source material for the cipher key (Cipherkey). A method using only a sufficiently large random data as the cipher key (Cipherkey) source material can also provide a secure cipher (Cipherkey) generation system for generation of the cipher key (Cipherkey). However, in the latter case an attacker will only need to produce a valid and sufficiently large random data to recreate a specific cipher key (Cipherkey), so the attacker will have fewer problems to solve than in cases where Hash1 values are utilized. Similarly, three, four or more data elements, in respect of which at least one element is random or at least pseudo random, can be combined and hashed. In fact, any number of elements can be combined to produce a combined data element to derive a cipher key (Cipherkey). Also, any process, suitable for practical purposes, for combining elements of data can be hashed to derive a cipher key (Cipherkey), including simple concatenation.

In a third aspect of invention, a user provides a password and an encrypted random data object, then methods and apparatus enable hashing the secret to produce a single hash value, Hash1, that is used as a first symmetric encryption key to encrypt and decrypt the random data. The Hash2 and Hash3 values are not calculated. In this aspect, the methods and apparatus do not create a Hash2 value that otherwise makes it possible for the system to locate a required encrypted large random data. Therefore in this aspect, the encrypted random data file must be provided by the user by some alternate means that can include placing it in a location that the system can find, for example a default location in the computer file system or by providing the location of the random data file in an additional form field displayed at the time users provide their passwords, being just two of many ways to provide the random data. In a next step, the methods and apparatus provide hashing random data to produce a cipher key (Cipherkey). According to this aspect of invention, the content of the decrypted random data file alone can be the source material for the cipher key (Cipherkey). Or alternatively, the bytes of data defining Hash1 can be combined with the content of the decrypted random data file to form the source material for generation of the cipher key (Cipherkey).

Aspects of invention enable a user to directly provide an encrypted random data file. In one aspect, the user provides input informing the computer system about a location to search in a cloud hosted computer data storage (non-transient computer readable memory) and requests a specific encrypted random data file from that storage. The cloud storage services typically store files in repositories called buckets. The computer system a user uses to connect to a cloud services provider can, in one aspect, be controlled by the user, so that the user will search and find a required encrypted random data file on the cloud. In another aspect the system can be controlled by a network administrator, not under a user's control, and the cloud services provider may grant access or refuse to grant access to an encrypted random data file needed for construction of a cipher key (Cipherkey). In another aspect the system can be controlled at a distance by a third party including an official belonging to an organisation or government and not a network administrator.

Since a cipher key (Cipherkey) cannot be created without a required random data according to present aspects of invention, different aspects of the disclosed invention can provide methods and apparatus where a network administrator is able to provide or refuse to provide an encrypted random data file requested by a user. For example, if a user is logging in from a valid IP address then the user can in one example be provided with the encrypted random data file they are searching for, but otherwise not.

The aspects of invention described in this section all provide methods and apparatus for protecting a computer system user's hidden data from access by an unauthorised intruder, where the hidden data is in most cases sensitive data, for example banking details or encryption keys. To conceal a user's hidden data, the system creates a symmetric encryption key called a cipher key (Cipherkey) created from one or more input items, with a sufficiently large random data object for practical purposes being an important item needed for construction of the cipher key (Cipherkey). A sufficiently long and complex secret passphrase or password provided by a user is not, in and of itself, the most important item providing practical security according to the inventor's systems, rather it is the presence of a plurality of security features in combination that provide effective practical security. The provision of the random data item makes the task of brute force generating a cipher key (Cipherkey) for hacking the security of the systems described by the inventor infeasible to implement. Indeed, in some aspects of the disclosed apparatus and methods, for example in an aspect where a user keeps the encrypted random data in storage on a detachable device, a user can use an unsafe password such as “MyName.03.06.2077” and their data can still be protected if the user keeps their stored random data file secure and inaccessible to others. Additionally, the required random data can be stored on a server or alternatively at remote locations either under the control of the server or a user and in some cases requiring verification by additional security features in order to access the random data. The sufficiently long array or stream of random bytes of data that is used in the disclosed methods and apparatus add great practical complexity to a cipher key (Cipherkey) being constructed.

The inclusion of this sufficiently large random data item needed for creation of a cipher key (Cipherkey) provides systems and methods that require the user to provide at least one input item for creation of the cipher key (Cipherkey). When a returning user, a person who created a cipher key (Cipherkey) at an earlier time, in a prior session of interactivity with a system, returns and re-enters their password using methods and apparatus provided by the disclosed systems, then either the user or a network services provider can supply the random data file needed for generating the cipher key (Cipherkey). The user must not only present what he/she knows, i.e. a password, an idea . . . some form of credentialing, but an item that the user can access, i.e. encrypted random data that gets decrypted with a symmetric key derived from the user's password. This is also true in an aspect where the encrypted large random data is stored in a bucket that is controlled by a network administrator, in which case a user will need to satisfy any criteria required by the network administrator, such as a requirement that the user should log in from at least one specific IP address and potentially also within a given time frame according to one aspect of invention, in which case the system will only enable a user to create a cipher key (Cipherkey) if the user provides a valid Hash2 search criteria corresponding to a specific IP address.

A random data object can contain thousands of random bits of data or be in the form, without limitation as to text length for practical purposes, of tens of thousands of text characters, when stored in a file inside a detachable device. The device can be either plugged in to a computer or completely detached from all computers and networks and stored in a safe in one case. Without the random data it will not be possible for an intruder to construct a valid symmetric key and decrypt a specific user's random data in order to derive a cipher key (Cipherkey). Alternatively, an encrypted random data file can be stored in a bucket provided by a cloud services provider, in which case the random data file can be made available to an authenticated user by the user requesting the computer system to search a bucket, which can occur in association with a user logging in from a valid IP address.

Different aspects of invention provide methods and apparatus for users to create a cipher key (Cipherkey) on their stand-alone computer, where all applied cryptographic operations are executed on the stand-alone computer. Alternatively, the cipher key (Cipherkey) can be created at a distance on a server, under control of a third-party administrator, from a secret password and a random data file that are stored on a networked cloud system or other non-transient computer readable medium located at a distance. A network administrator can retain possession of a random data file needed for creation of a cipher key (Cipherkey), in which case the administrator then has a means of controlling a user's ability to log in and to use the cryptographic functionality provided to users of the network.

In summary, the aspects of invention disclosed in this specification provide secure methods and apparatus of generating a symmetric encryption key for protecting a computer system user's hidden and often highly sensitive data. In other aspects the symmetric key can actually be used to decrypt an asymmetric key or for that matter any other sensitive data required to provide practical security. Computer systems, controlled by at least one server, using any of these aspects can provide secure encryption and decryption functions for a system and associated users. To gain access to hidden data an attacker needs an encrypted random data, a Hash3 key, for deciphering the random data, and the additional hash value, Hash1, as explained above. Attempts to create a user's cipher key (Cipherkey) by brute force generation of random values is infeasible, because the high entropy input required to create a user's cipher key (Cipherkey) makes generation of the cipher key (Cipherkey) infeasible on a trial and error basis. A sufficiently long and complex password is not the exclusive provider of security for data protected by a cipher key (Cipherkey) generated by methods and apparatus disclosed in this specification. Aspects of the disclosed invention require that an input item that can contain many thousands of random data characters should be provided when a cipher key (Cipherkey) is being generated. The data defining the decrypted random data object effectively extends the size of the user provided input data used for providing a cipher key (Cipherkey) needed for login. The decrypted random data advantageously being data with a length of many thousands of characters, it consequently provides that a cipher key (Cipherkey) will be the product of hashing a source material data of massive size. Additional safeguards including the need to log in from a remote location prior to executing a task, which could include in one case biometric security features including voice recognition, and the inputting of additional information including data provided on detachable storage devices, radio frequency (RF) devices located on a user's person or additional involvement of asymmetric keys can all complement the security of the present aspects of invention.

A cipher key (Cipherkey) is used to decrypt a user's configuration data.

Configuration data is encrypted data that, when decrypted, provides a collection of encryption key seed materials and master keys contained in a structured data object. An encrypted configuration object can be stored in a plurality of locations, including in a detachable data storage device, in the local data storage of a computer system, and in a storage area of a coupled network, all data being stored on non-transient computable readable media. In some aspects of the system, it can be preferred to store all data and substantially to provide all critical operations on a server and under the control of the server's network administrator, to which a user can be coupled.

When encrypted configuration data is decrypted the system can read and execute instructions in the data, configuring the system and providing interfaces for a user, enabling the user to use the system's cryptographic and other functions for creating and distributing encrypted files which can be sent to other users of the network.

After first being created by a computing system, configuration data can be written as a file that is stored in computer storage on a non-transient computer readable medium. The system can store the encrypted configuration data file in a default location on the computer system. The configuration file can also be given a name that can facilitate the finding of the file when the system seeks the file. One method of enabling this process is to hash the cipher key (Cipherkey) in order to create a text string that can be used for the name of the encrypted configuration data. Then when a user provides their password and the encrypted random data and generates a cipher key (Cipherkey), the system can compute the text string used as the name of the encrypted configuration data and find that configuration file and decrypt the encrypted configuration data.

### BRIEF DESCRIPTION OF THE DRAWINGS

FIG. 1 is a flowchart illustrating a plurality of methods for calculating a symmetric encryption key for protecting a computer system user's hidden data according to various aspects of invention. In one aspect of invention, the cipher key (Cipherkey) source material [111] is a Hash1 value [113] and random data [115] that are joined together and hashed in a process [117] that produces a symmetric encryption key being a cipher key (Cipherkey) [119]. In a second aspect, the source material [111] is only the random data [115].

FIG. 2 illustrates an aspect of disclosed invention, an aspect where a user has possession of an encrypted random data file [137] stored on a detachable device [135].

FIG. 3 illustrates an aspect of disclosed invention, an aspect where a user's encrypted random data file is stored in a bucket [141] provided and controlled by a cloud services provider at a remote location from where the user can download and use a random data file.

FIG. 4 illustrates an aspect where a user's encrypted random data file is stored in a bucket provided by a cloud services provider, where the user does not have direct access to the file in the bucket, which is owned, managed and provided by a system administrator [147] to the user.

FIG. 5 shows a method [149] according to which a computer system user interface is provided for a user to enter input required for calculating a cipher key (Cipherkey). A form field [151] is provided for a user to enter a secret passphrase or password. A second form field [153] is provided for a user to provide information identifying an encrypted random data file required for creation of a cipher key (Cipherkey).

FIG. 6 shows an apparatus and method [155] for generating a cipher key (Cipherkey) for a new user, according to one aspect of invention.

FIG. 7 is a flowchart, according to one aspect of invention, showing an apparatus and method [177] for regenerating a cipher key (Cipherkey) for a returning user of the system who has used the system before.

FIG. 8 is a flowchart showing a method [193] for generating a cipher key (Cipherkey) for a new user, according to a further aspect of invention.

FIG. 9 is a flowchart showing a method [201] for regenerating a cipher key (Cipherkey) for a returning user of a system, according to another aspect of invention.

FIG. 10 is a flowchart showing a method [217] for generating a cipher key (Cipherkey) for a new user, according to an aspect of invention. A random data file that is encrypted with Hash1 [223] is stored as a file or database record [175], being given an identifier value or signifier that is a text string derived from Hash2.

FIG. 11 is a flowchart, according to one aspect of invention, showing a method [225] for regenerating a cipher key (Cipherkey) for a returning user of the system. Two hash values Hash1 and Hash2 are calculated by hashing the user's secret password using two different hashing algorithms

FIG. 12 is an illustration of the contents, according to one aspect of invention, of unencrypted configuration data [123], data that is encrypted and decrypted with a cipher key (Cipherkey).

FIG. 13 shows an AES-GCM encrypted item stored as a file [243], showing an IV (Initialization Vector) and an AAD (Additional Authenticated Data) appended to the file.

### DETAILED DESCRIPTION

### Definitions, Abbreviations and Qualifications

The expression, “A or B” is taken to be used in an inclusive sense to denote cases that are true, in the alternative when: A but not B is true or; B but not A is true or; when A and B are both true.

The expression “invention” pertains to alternative aspects of invention.

The expressions “include” and “comprise/comprising” are used in a non-exhaustive sense meaning that if “A includes/comprise/comprising: B and C” that other items can also be included in A to give practical effect to the inventor's broad inventive concepts.

The indefinite article “a/an” denotes at least one item meaning that if a reference is made to “a server” or “an item” then the reference refers to at least one server or at least one item respectively.

Un-based dimensions, for example, “large”, “high” or “big” are to be taken to mean that the subject matter qualified by the adjective in question is sufficiently large, high or big for practical purposes. Accordingly, describing a key as being a “large key” means, in the present security context, that the key is sufficiently large to provide effective practical security.

Discussion of other references, including third party patent applications and patents and technical treatises, in the present specification and associated prosecution history does not contain an admission against interest by the inventor that the inventor's contribution resides in the references or more generally in the background art or that the references are relevant to patentability of the inventor's claimed subject matter for purposes of novelty or inventive step/non-obviousness.

Inclusion of claims in the specification is not to be construed as limiting the scope of the inventor's broad inventive concepts as claimed and in particular is not a waiver of rights to seek entry of broader or even narrower claims or to claim subject matter not presently claimed in the present application or in future applications being either independent applications or continuations/divisional filings of this or other related applications.

Application: a computer program designed to assist in the performance of a specific task: Microsoft Computer Dictionary, 5^{th} Edition, 2002.

Additional Authenticated Data (AAD): The input data for an authenticated encryption function, where the data can be authenticated but need not encrypted.

AES: Advanced Encryption Standard.

Authentication, used generally: is the act of confirming the truth of an attribute of data claimed to be true by an entity: adapted from Bertram L, Dooble, G van, Nomenclatura, 2019.

Authenticated Decryption: The function of GCM or any other encryption process suitable for aspects of the present invention, in which the ciphertext is decrypted into the plaintext, and the authenticity of the ciphertext and the AAD, in the case of GCM, is verified.

Authentication Tag (Tag): A cryptographic checksum on data that is designed to reveal both accidental errors and the intentional modification of the data.

Bit: A binary digit: 0 or 1.

Block: For a given block cipher, a bit string, whose length is the block size of the block cipher.

Block Cipher: A parameterized family of permutations on bit strings of a fixed length, where the value that is defined by a given permutation is a bit string called a key in context of a Block Cipher.

Block Size: For a given block cipher and key, the fixed length of the input (or output) bit strings.

Bucket: A region of memory that is addressable as an entity and can be used as a receptacle to hold data: Microsoft Computer Dictionary, 5th Edition, 2002.

Byte: A sequence of 8 bits.

Cipher, generally: in cryptography, a cipher is a process for performing encryption or decryption, being a series of well-defined steps that can be followed as a procedure: adapted from: Bertram L, Dooble, G van, Nomenclatura, 2019. In the present context a cipher key, written as a variable as Cipherkey, can include a key used to encrypt and decrypt sensitive/secret data that can include Configuration Data: in one aspect, the cipher key (Cipherkey) can be an AES-GCM key: alternatively in other aspects the cipher key can be any symmetric or asymmetric key derived from encryption or hashing algorithms generated according to aspects of present invention: the cipher key can be used to decrypt Configuration Data to produce keys that can either be symmetric or asymmetric for use in providing practical security, where to cipher means to encrypt or decrypt data.

Cipher key (Cipherkey): Generally, a key used in a cipher process that can include in one aspect a sequence of bits providing an AES-256 symmetric encryption key.

Cipher text (Ciphertext): An encrypted form of the plaintext. Generally, cipher text is the result of encryption performed on plaintext using a process called a cipher: adapted from Bertram L, Dooble G van, Nomenclatura, 2019.

Configuration, used generally in a security context: is related to security configurations of servers, devices or software: adapted from Bertram L, Dooble G van, Nomenclatura, 2019.

Configuration Data: Data that can be encrypted or unencrypted but when encrypted and so subsequently decrypted according to one aspect, can contain a collection of structured data with a Entry Point Data and collection(s) of encryption keys and associated parameterised values, and additional data in JSON, XML, YAML and/or other formats used for configuring computer systems.

Data Structure: An organization scheme, encoded in a non-transient computer readable medium, that can include a record or an array, that can be applied to data to facilitate interpreting the data or performing operations on the data: adapted from Microsoft Computer Dictionary, 5th Edition, 2002.

Encrypted Large Random Data: sufficiently large random data encrypted with a key that can be a symmetric key according to one aspect or an asymmetric key according to another aspect, where the key is derived by hashing or encrypting a user provided password in order to provide practical security.

Encrypted User Data Identifier: an identifier value that can be a hash value indicating a file containing user data. If a file needs to be tracked the file requires an ID (identification) value and a hash value is a simple way of facilitating file tracking: then an application can send a request to a server for a file, or look in a local file system or USB for a file that has this identifier, a Hash value used as the file's filename.

Encrypted Private Data Identifier: generally, an identifier for encrypted private data, that in one aspect, can be a string produced by encrypting or hashing in association with a cipher key (Cipherkey) including in one aspect, hashing a cipher key, the Identifier string can be used as a signifier or file name for encrypted user data.

Encryption: The process of encoding data to prevent unauthorized access, especially during transmission. Encryption is usually based on one or more keys, or codes, that are essential for decoding, or returning the data to readable form: Microsoft Computer Dictionary, 5th Edition, 2002.

Entry Point Data: A file containing first instructions a computer system can execute after the computer system generates a decrypted Configuration Data.

Fresh: For a newly generated item including a key, the property of being unequal to any previously used key.

GCM: Galois/Counter Mode.

Hash Function: any function that can be used to map data of arbitrary size to fixed-size values. The values returned by a hash function are called hash values, hash codes, hash sums, or simply hashes. A cryptographic hash function is a function which is considered practically impossible to invert: Bertram L, Dooble, G van, Nomenclatura, 2019 and Wikipedia.

Identification: the capability to find, retrieve, report, change or delete specific data, without ambiguity: adapted from Bertram L, Dooble, G van, Nomenclatura.

Initialization Vector (IV): A nonce that in one aspect is associated with an invocation of authenticated encryption on a particular plaintext and AAD.

IV: Initialization Vector.

Key, used generally: in encryption and digital signatures, a string of bits used for encrypting and decrypting information to be transmitted: Microsoft Computer Dictionary, 5^{th} Edition, 2002: in one aspect, in context of block ciphers: the parameter of the block cipher that determines the selection of the forward cipher function from the family of permutations.

Large Random Data: A sufficiently large random sequence of bits with a length, according to one aspect, of more than two hundred and fifty-six bits, being a length that is sufficiently large to provide practical security.

Login: In computer security, logging in (or logging on or signing in or signing on) is the process by which an individual gains access to a computer system by identifying and authenticating themselves: Bertram L, Dooble, G van, Nomenclatura, 2019.

Mode of Operation (Mode): generally, a particular form or way of performing a process: according to one aspect, an algorithm for the cryptographic transformation of data that is based on a block cipher.

NIST: National Institute of Standards and Technology.

Nonce: A value that is used only once within a specified context.

Password: A password can include a word or string of characters used for user authentication to prove identity or access approval to gain access to a resource (example: an access code is a type of password), which is to be kept secret from those not allowed access: Bertram L, Dooble, G van, Nomenclatura, 2019. Generally, a password can include: alphanumeric text, a geometric shape as input, biometric data, or more broadly any item of information only known by or insertable as input only by a valid user of a computer system.

Persistent Data: generally, Persistent Data means that a data element is stored on a non-transient computer readable medium.

Random data, generally: data that is truly random or pseudo random, that is data that is sufficiently random for practical purposes.

Secret data: An input item provided by a user: in one aspect, secret data can include a password: generally, secret data is data that is kept from general knowledge or view: adapted from Merriam-Webster Dictionary.

Signifier: being in one aspect a Configuration Data Identifier; a value that can be, in one aspect, a hash value is an ID (identifier) for a file, where an application searches for the file and decodes the file.

Signifier: From the study of Semiotics, a signifier is a sign stored in a material form, something which can be seen, heard, touched, smelled or tasted, which communicates a fact, the meaning of this fact being correctly understood when it is examined in its full context.

XOR: Exclusive-OR.

Aspects of the present invention, according to the inventor's broad inventive concepts, provide methods and apparatus for protecting data from access by unauthorised intruders. To protect data stored within computer systems, aspects of the present invention provide methods and apparatus for a user to control the encrypted assets that they possess, whether the assets are stored on local computer systems or on networks. Aspects of the present invention also provide methods and apparatus enabling a network administrator to allow a specific user to use cryptographic functions provided by a computer system, or to refuse and block a user from using the system. The following detailed description refers to the accompanying illustration figures demonstrating aspects of invention. Apart from the aspects shown here, other aspects are possible using functionality described in the aspects of invention as presented, without departing from the scope of the inventive disclosure. This disclosure provides details of methods and apparatus that are best aspects of invention and the advantages that those aspects provide.

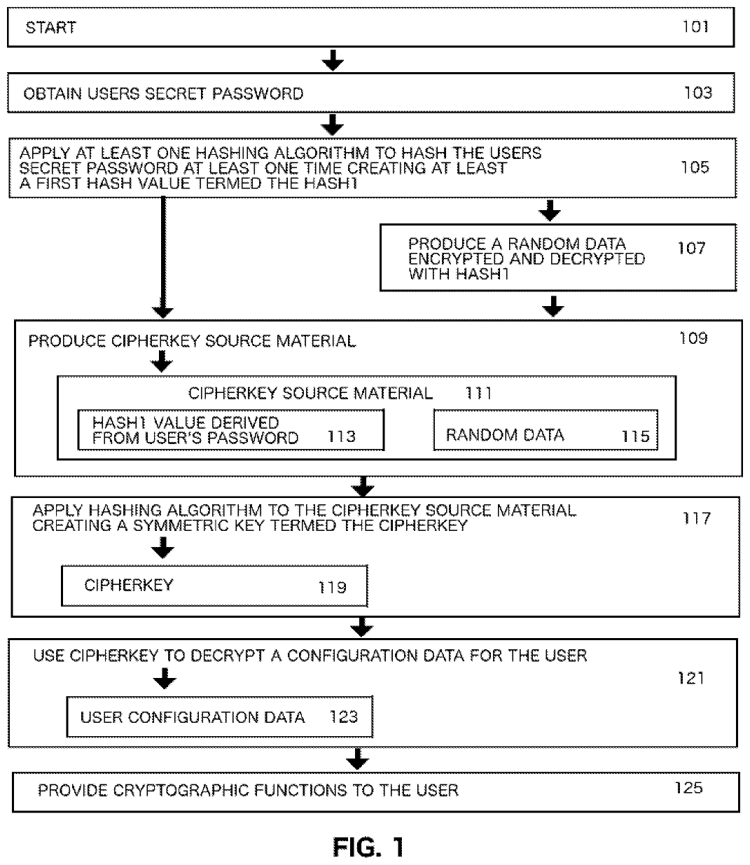

FIG. 1 is a flowchart illustrating a system and method for calculating a symmetric encryption key termed a cipher key (Cipherkey) used for protecting a computer system user's hidden data. At the start [101], a computer system provides an interface for a user to input a secret password, preferably a long and complex string of text.

A user of the system can enter a complex secret phrase or nonsense password such as the following:

### ?8Plus9isNot4

A system obtains a user provided password input value [103], that is then provided to step [105] that calculates one or more hash values using one or more one-way hashing algorithms that can include SHA256, SHA384 and SHA512. In different aspects of the disclosed invention one, two or three different hash values can be created, which can be termed Hash1, Hash2 and Hash3. These hash values are all derived using different hashing algorithms. One hash value derived from the user's password, either Hash1 or Hash3, according to aspects of invention, can be used as a first symmetric encryption key.

In the next step, a step [107] produces a large random data object, an input needed for creation of the cipher key (Cipherkey), where the large random data object is sufficiently large to provide effective security for practical purposes. In different aspects of the disclosed invention, the large random data is produced in different ways. In the case of a first-time user, a computer system can generate a large random data object [115] and provide that data as input to the method for generating a cipher key (Cipherkey), then the random data [115] can be encrypted with a first symmetric encryption key produced from a first hash value [113], either Hash1 or Hash3 according to aspects of invention. In the case of a previous user who is logging in again and recreating a cipher key (Cipherkey), the random data object is obtained from non-transient computer readable memory in computer storage and then the system can perform a step of decrypting the data using a first symmetric encryption key [113] and then execute a step of providing the large random data object to produce source material for a cipher key (Cipherkey).

The process of producing the cipher key (Cipherkey) source material [109] can produce one, two or more items as the source material [111] according to various examples. In some aspects of the disclosed invention, a single unencrypted random data alone can be the source material of a cipher key (Cipherkey). In another aspect of invention, the source material includes two objects, an unencrypted random data object [115] and a Hash1 value [113] derived from the user's password. In a further aspect, not one but a plurality of unencrypted random data objects may be produced and used as source material, the mechanism for this being that the system generates a plurality of different unencrypted random data objects that are stored in a network or more generally in an accessible location from where each random data object can be retrieved and decrypted, by means of the same first hash value; said locations being under the control of an administrator or network administrator. The advantageous result of this being that since the plurality of unencrypted random data must be available in order for a particular cipher key (Cipherkey) to be produced, the system provides a method where an administrator or administrators can employ techniques for restricting access to the plurality of random data objects under their control, thereby providing mechanisms so an administrator can be certain a key can never be generated except when the required random data they control is made accessible. In one aspect of this method, when a cipher key (Cipherkey) is created for the first time, a plurality of network administrators can each take possession of a share of the plurality of unencrypted random data objects, with the result that this plurality of network administrators must assent and provide their shares any time a particular cipher key (Cipherkey) is going to be regenerated.

In a step [117] the method applies a hashing algorithm to calculate a hash value termed a cipher key (Cipherkey) object [119], a second symmetric encryption key. When the method generates a cipher key (Cipherkey) for a user, the system then uses the cipher key (Cipherkey) for decryption and encryption [121] of a user's configuration data [123] that contains secret information including at least one randomly generated symmetric encryption key. More generally, the configuration data can include asymmetric keys or for that matter any security features that are suitable for providing effective practical security.

Persons skilled in the art can understand that when one randomly generated symmetric encryption key is produced by the method illustrated this key can provide many kinds of functionality for a user. Apparatus and methods derived from aspects of the invention can provide many different interfaces with which a user can interact, enabling a user to encrypt and decrypt documents, files, video, audio and streaming data, and to work with other data types. Other modes including best modes, pertaining to aspects of invention, will now be considered.

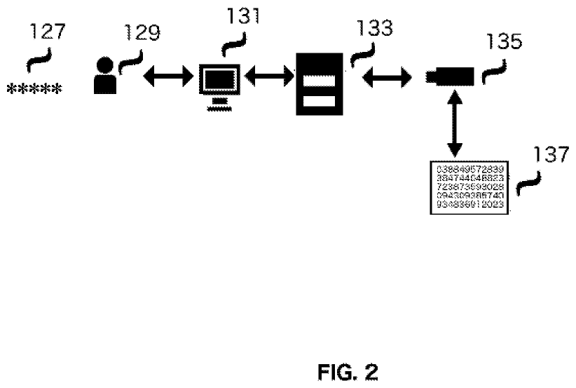

FIG. 2 shows a password object [127] provided by a user [129] interacting with a user interface [131] of a computer system [133]. A detachable device [135] that can include a USB memory stick can contain an encrypted random data file [137] required by the method for creating a cipher key (Cipherkey). Methods and apparatus can create at least a single hash value Hash1 by hashing the user's secret password and this hash value can then be used as a first symmetric encryption key to decrypt an encrypted random data file [137] and provide the random data that the file contains to the process for creation of a cipher key (Cipherkey).

A method where a password is provided by a user has been shown. Persons skilled in the art will know that instead of a password entry system, other systems can also be employed. A user may enter a password comprised of alphanumeric text, a geometric shape input, biometric data, or more generally any item of information only known by or more generally insertable only by the valid user of a computer system. As a further example, a user may attach a device to the computer system and this device may provide the unique data described as the “password” that is required for producing the hash values Hash1, Hash2, Hash3 etc.

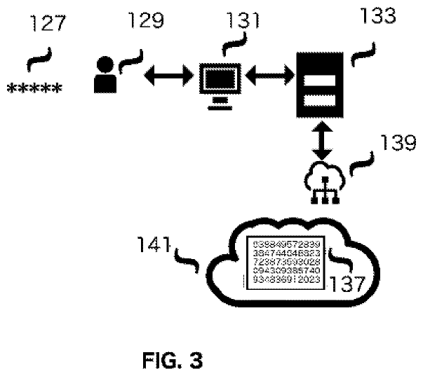

FIG. 3 shows a different aspect of invention, showing an encrypted random data file [137] stored in a bucket [141] provided by a cloud hosting services provider connected to the user's computer system by a network [139]. The encrypted random data file [137] stored in the bucket can be identified by a text string derived from a second hash value termed Hash2.

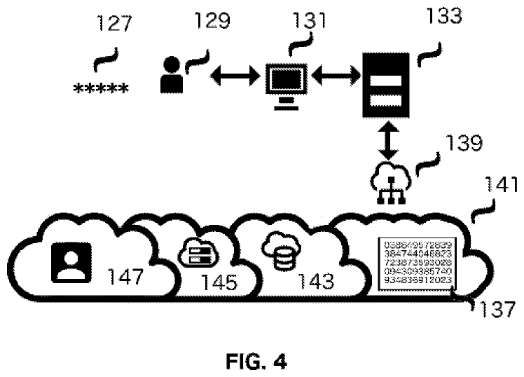

FIG. 4 illustrates two aspects of invention. In one aspect, an encrypted random data file [137] stored in a bucket provided by a cloud services provider is not owned or immediately available to a user, rather the random data file [137] is controlled by a network and the network's administrator [147]. In a second aspect, the encrypted random data file [137] is owned and controlled by a user and the user can access the bucket and copy or delete resources that are stored in the file. FIG. 4 further illustrates how an administrator can have multiple resources at his/her disposal, including a collection of computer software applications [145] for administering access to a user's random data [137], as well as information about the user and his/her data which is stored in a database or information storage container [143]. By collecting information and assessing information, an administrator can have sufficient information to be able to determine if a user should be provided with specific random data or denied access to that data, according to one aspect of invention.

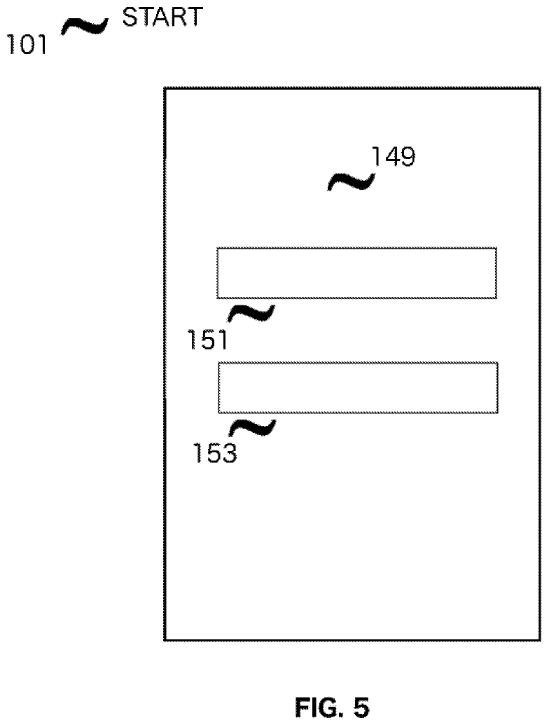

FIG. 5 shows a user interface presented to a user by a method [149] provided at the start [101]. The method provides an interface for a user to enter a secret in a form field [151] and a second form field [153] where a user can provide information identifying an encrypted random data file required for creation of a cipher key (Cipherkey), such as the name of a file stored on a USB mounted storage device. In some aspects of invention, the method can generate two or more hash values from the secret provided by the user, then a hash value Hash2 can be used to produce search criteria for finding a random data file or files stored in network or in a bucket by a cloud services provider. The second form field [153] need not be displayed to a user according to some aspects of invention, in which case the system can include information about locations to be searched to find a needed random data file.

According to aspects of the disclosed invention, two or three hash values can be derived from a user's secret/password. The first aspect of invention described in the Summary of Aspects of Invention can be difficult for an intruder to attack as not two but three hash values are used. In this aspect, the method provided involves generating three different hash values derived from the user's secret, the Hash1, Hash2 and Hash3 values. To gain access to hidden data, an attacker needs encrypted random data, a Hash3 key for deciphering the random data, and the Hash1 value included in the cipher key (Cipherkey) source material, before the attacker can recreate a user's cipher key (Cipherkey). Further extending this aspect, four, five or more different hash values derived from different hashing algorithms can be used, with the fourth and additional hash values being used to decrypt a plurality of random data objects; alternatively, a different part of the Hash1, Hash2 or Hash3 values can be used other than the parts used for other procedures that have been mentioned. This can be done because a hash value generated using the SHA384 and SHA512 hashing algorithms will be an output with a greater length than the required length of 32 bytes (256 bits) required for creation of an AES-256 symmetric encryption key, thus the extra part of a SHA512 generated hash value can be made use of in this way.

The aspects of the disclosed invention described in the Summary of Aspects of Invention above can be based upon a method that derives: Hash1, Hash2 and Hash3 values from a user's secret/password. Aspects of invention derived from methods and apparatus that generate just one or two hash values can also provide, in some cases, effective protection for data that needs to be hidden. Methods and apparatus that extend the functionality of the first aspect discussed in the Summary above can provide effective practical protection. Persons skilled in the art will know that a method employing three or more hash values is more difficult to challenge than a system that makes use of just one or two hash values, and therefore the best aspects of invention are to be used in a preferred aspect.

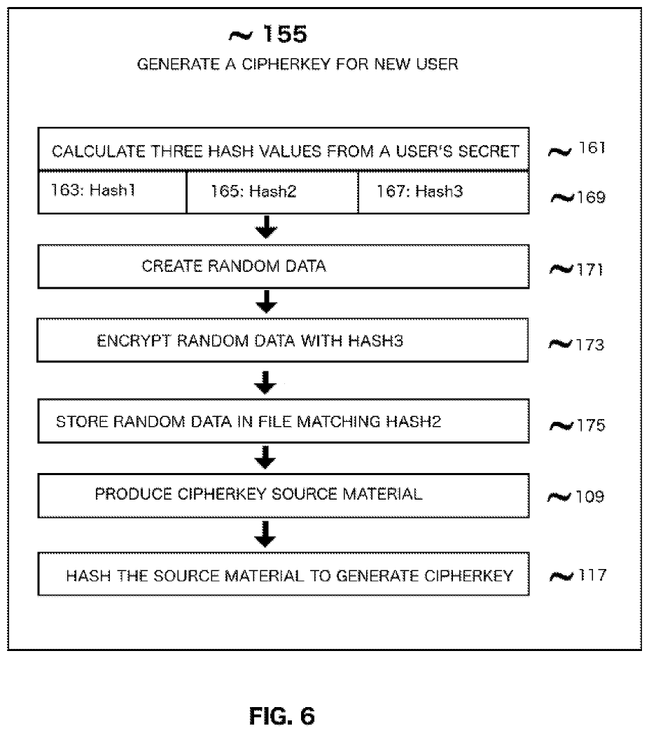

FIG. 6 is an exemplary illustration of an apparatus and method [155] for creating a cipher key (Cipherkey) for a new user of a system. The system performs a calculation [161] to create a collection [169] of three hash values Hash1 [163], Hash2 [165] and Hash3 [167] from the passphrase input (secret/password) using three different hashing algorithms. The system [171] generates a random data object then that random data object is encrypted [173] using the Hash3 hash value as a symmetric key. In the next step [175] the encrypted random data is stored as a file or database record in a computer storage container. Next, the unencrypted data generated in the process [171] is joined with the bytes of data in Hash1 in a process [109] to provide a joined data object. Finally, in the process [117], the joined data is hashed using a one-way hashing algorithm which outputs a hash value, a cipher key (Cipherkey), as a result of the hashing algorithm. Hash1 can be concatenated with the unencrypted data as above. However, in another aspect, any mode of combining Hash1 and the unencrypted data that results in practical security can be implemented.

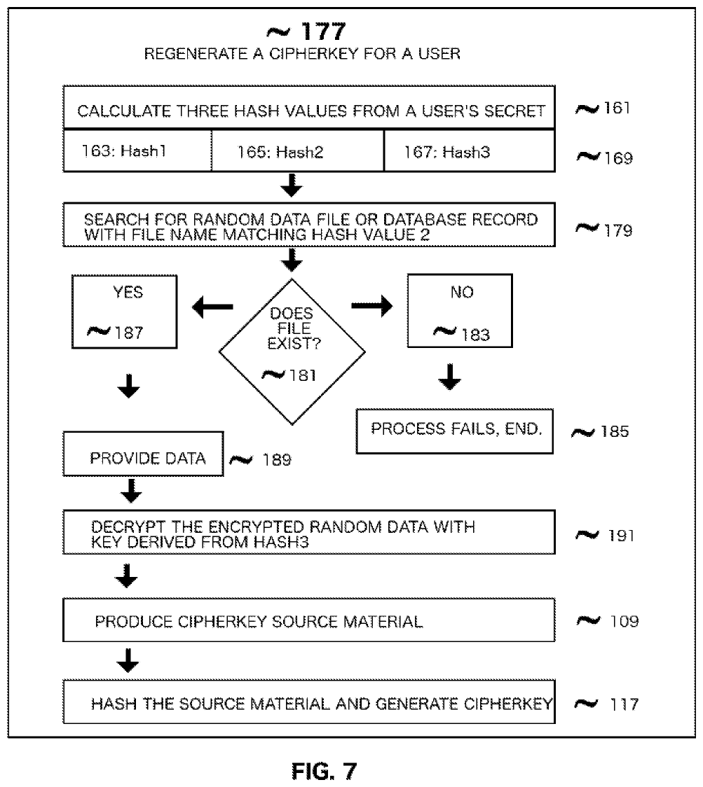

FIG. 7 is an exemplary illustration of an apparatus and method [177] for recreating a cipher key (Cipherkey), for a user who is logging in to the system after logging out at the end of a first session of interactive engagement. As in FIG. 6, the system can perform a calculation [161] to compute a collection [169] of three hash values Hash1 [163], Hash2 [165] and Hash3 [167] from the passphrase (secret/password) input provided by a user. The system can then perform a search operation [179] looking to see if a file exists [181] matching the search criteria, the value Hash2 [165]. In the event that the file is not found [183] the process terminates [185]. If a matching file is found [187] the system reads the file and provides [189] the file data to a function that decrypts the file [191] using Hash3 as the symmetric encryption key. Next comes a process [109] to produce a cipher key (Cipherkey) source material, which in one possible aspect involves joining Hash1 [163] and the decrypted random data [115] producing combined data. In a final step [117], the method hashes the combined data and produces a symmetric key, being a cipher key (Cipherkey).

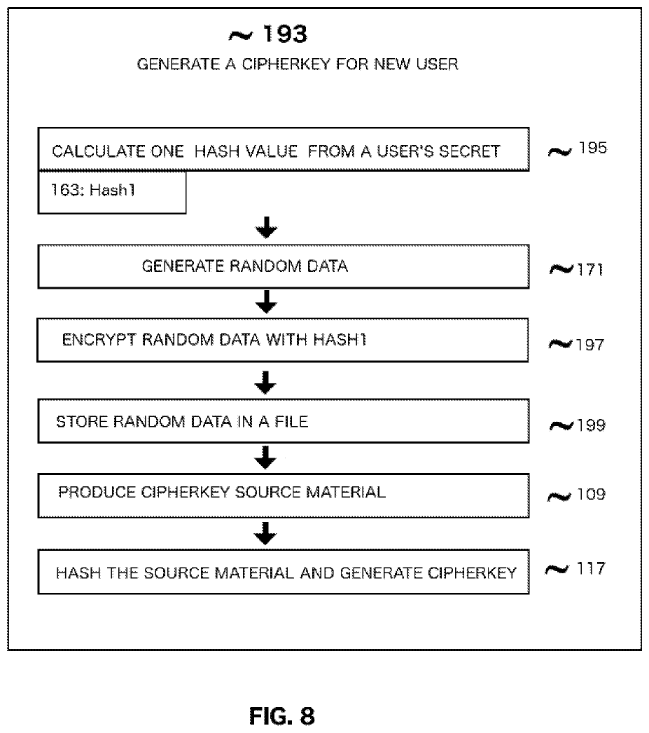

FIG. 8 illustrates a third aspect of invention, an aspect where a method [193] can calculate [195] just one hash value, Hash1 [163], from the user's secret/password when a new user of the system first starts to use the system. The method creates a random data object [171] then the method encrypts [197] the random data with Hash1 [163]. The encrypted data is then stored as a file [199], but not with a filename that is derived from a hash value permutation of the user's secret. The encrypted random data file can be provided to the user by placing the encrypted random data file in a location that the user can find on his/her computer system, or the system can assign a name to the file and store the encrypted random data file in a default location. The method, in this event, cannot provide the functionality of searching for the encrypted data file by way of a file identifier or signifier derived from a hash algorithm, and consequently when the user has to provide the file to the system the user can use a method that could include use of a form field [153] provided by the method [149], or the system can retrieve the file from a default location. Next comes a process to [109] produce a cipher key (Cipherkey) source object. Finally, the method hashes the cipher key (Cipherkey) source object and provides a cipher key (Cipherkey) for decrypting user data.

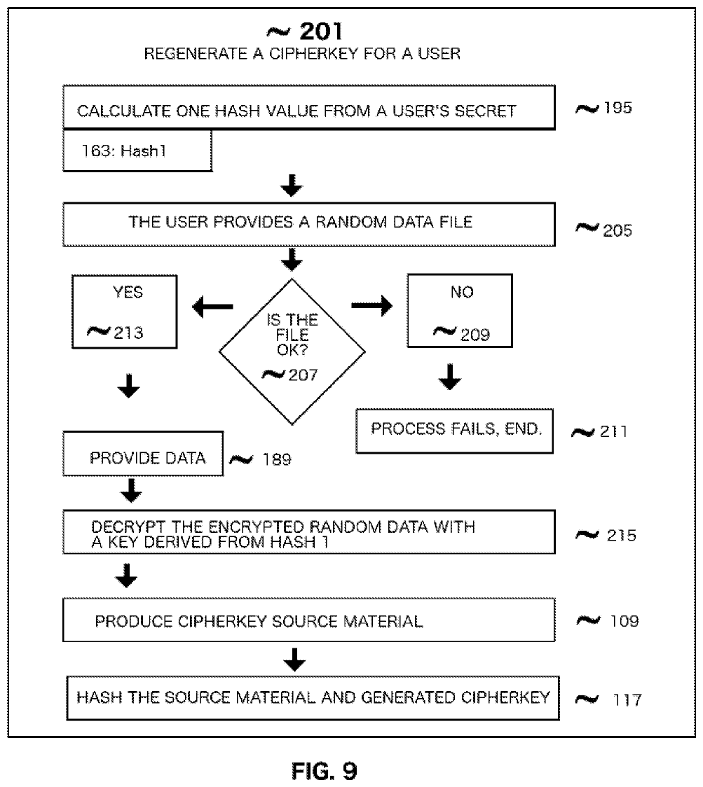

FIG. 9 is associated with FIG. 8. FIG. 9 illustrates how a method [201] can calculate just one hash value Hash1 [163] when a returning user is logging in again for a new session of interaction with a system. An encrypted data file [205] is provided, possibly by the user entering the name of the file in a form field [153], or by other possible means including when the file is stored and available in some default location the system can examine. The system may check the file [207] and if the system determines the file [207] is invalid [209] the process is terminated [211]. If the file [207] is valid [213] then the file is provided [189] to the method for creating a cipher key (Cipherkey). The file is decrypted [215] using a symmetric key, Hash1 [163] derived from the user's secret, then a process [109] to produce a cipher key (Cipherkey) source material is performed. Then the cipher key (Cipherkey) source material/object is hashed [117] resulting in the production of a value that can be used for a cipher key (Cipherkey), a symmetric encryption key.

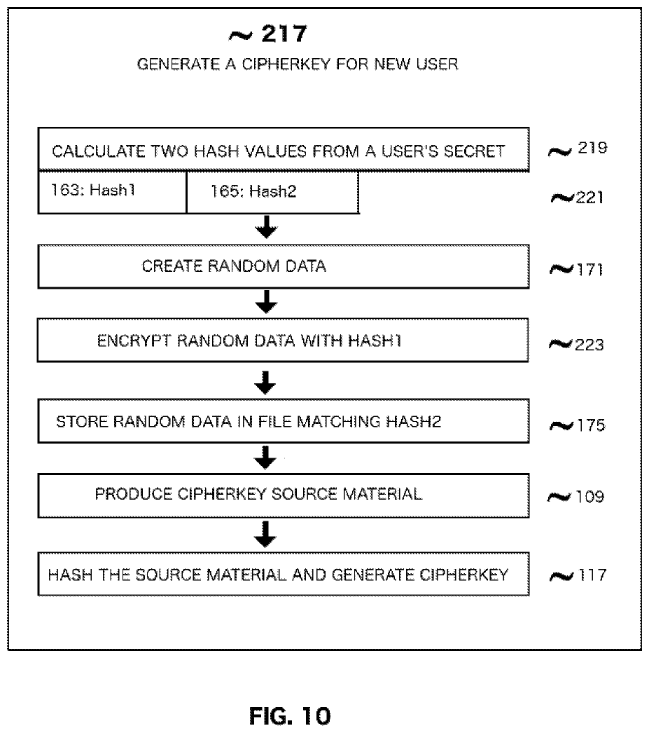

FIG. 10 is a flowchart illustrating an aspect, with a method [217] generating a cipher key (Cipherkey), calculating [219] a collection [221] containing two hash values Hash1 [163] and Hash2 [165]. The method shown here is similar to the method shown in FIG. 8. where the random data is encrypted with Hash1. In the aspect depicted in FIG. 10 the random data is stored in a file or as a database record identifiable by a text derived from Hash2, thereby providing methods and apparatus that search for the file in locations including a bucket provided by a cloud services provider.

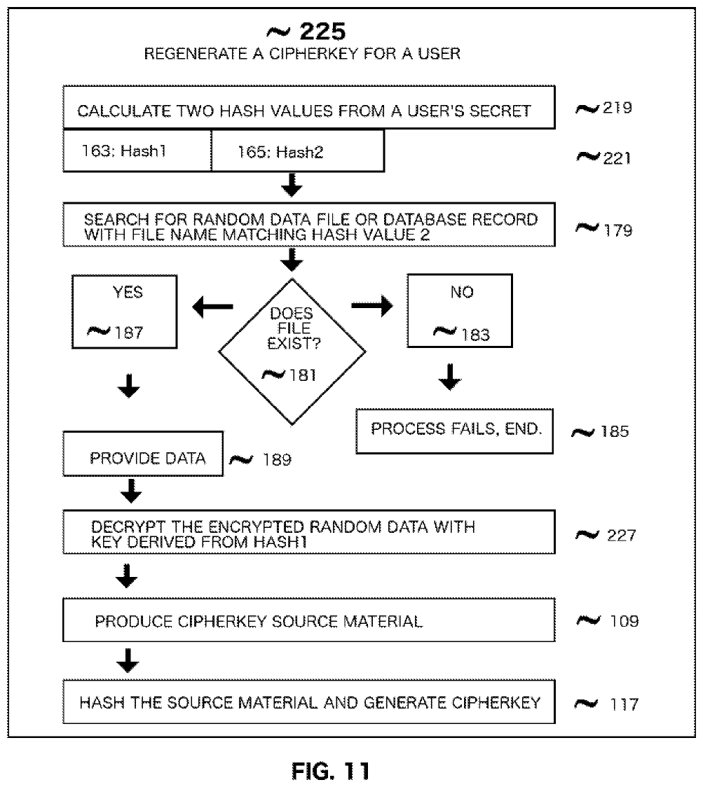

FIG. 11 shows a method [225], which is associated with the method [217] depicted in FIG. 10, involving calculating [221] two hash values Hash1 and Hash2 and searching [179] for a random data file identifiable by a text string calculated from Hash2. In this method [225] the random data is decrypted using Hash 1.

When a user first begins to use the disclosed system, apparatus and associated methods, a process can generate configuration data that can contain a plurality of randomly generated symmetric and/or asymmetric encryption keys.

Whenever files or data belonging to the logged-in user need to be encrypted by the system, the system can use one of the randomly generated symmetric keys to complete that task. The cipher key (Cipherkey) derived from the user's secret/password should not be used for encryption of files or shared data.

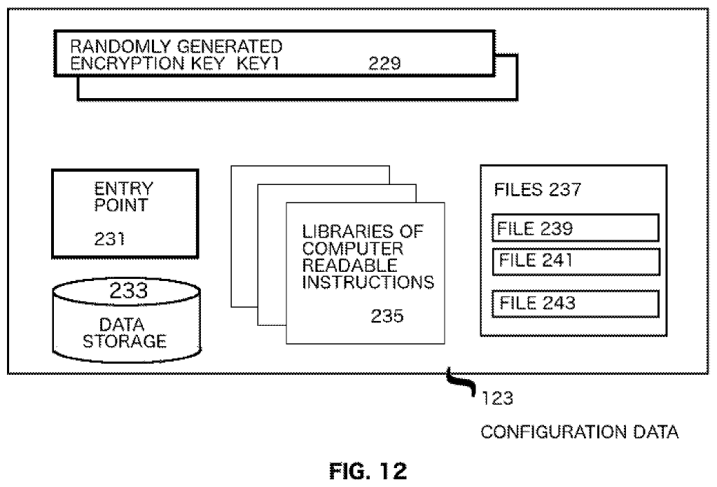

FIG. 12 illustrates a configuration data [123] that contains a randomly generated symmetric encryption key, key1 [229]; entry point data [231]; data storage [233], a library of computer readable instructions [235] and a collection of files [237] including example encrypted files: file [239], file [241] and file [243]. These items are exemplary, and persons skilled in the art will know that a configuration data [123] can contain a range of different items.

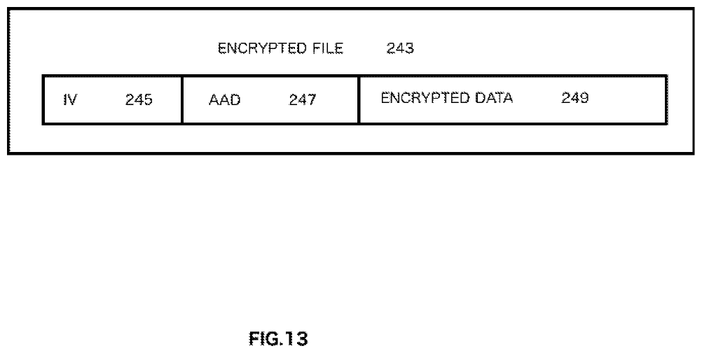

FIG. 13 shows details of an example encrypted file [243], an AES-GCM encrypted file. In this example, encrypted file [243] including the encrypted file data [249] are appended with an IV [245] and an AAD [247] which are stored in the file as the first bytes of the file. The GCM mode that includes the IV and the AAD provides practical tamper protection. The IV will contain information about the symmetric encryption key required for decryption of the file.

After a user begins using applied cryptographic functions provided by aspects of the disclosed invention, the system can record and store information for the benefit of a user. Whenever a file or data stream is encrypted by methods and apparatus provided by the disclosed aspects of invention, the system can produce new information about the input and encrypted data that is being produced. Cryptographic functions provided by the system create meta-data relating to the input data, including information about such things as a file's original file name, creation date, file size, file type, and a hash value checksum derived from the input of the unencrypted file. This information can be stored within a user's configuration data, within data storage [233] on non-transient computer readable memory. When new information is added to the configuration data, in one aspect a new AES encrypted configuration data will be produced and the old encrypted configuration data can be destroyed. In one aspect, the old encrypted configuration data may not be destroyed but may instead be archived, according to methods of archiving data known to people skilled in the art. Any time a new version of the encrypted configuration data file is produced a new IV and AAD will be generated for the file.

Further, when a new configuration file has been encrypted then, optionally, the previous file can or cannot be deleted from the computer system, pursuant to instructions that are received from the user, according to alternative aspects of invention. The user can have access to interfaces where the user can make choices about how his/her data is preserved. A user can see meta-data about each encrypted file, and can restore, decrypt and view all the files that have been encrypted by methods and apparatus provided by aspects of the disclosed invention. This meta-data can also be stored within data storage [233] on non-transient computer readable memory.

In aspects of the invention, a method can produce not a single file but a plurality of files containing an encrypted configuration data, a private data. All of these files can be decrypted with the same cipher key (Cipherkey). The encrypted encryption keys can be placed in a different file from an encrypted configuration data, and keys or metadata created at a later time can be stored in additional files and encrypted with the cipher key (Cipherkey). An apparatus can apply a method for transforming the cipher key (Cipherkey) value into a text, then using this text as a file name identifier for identifying and storing a plurality of encrypted files in a persistent data structure, including in a key-value database, or in structure where each encrypted file is stored as a value associated with a key derived at least in part from the file name identifier. Or, applying a method for storing a plurality of encrypted files in a directory in a persistent data structure, the directory can be identifiable at least in part by a file name identifier.

The disclosed aspects of invention can also provide methods and apparatus so that when a user is ending a session of interactive engagement and is logging out, a synchronising function can be run so that all the unencrypted files a user has been viewing can be deleted from a computer system. Before any file is encrypted the file can be hashed to produce a fingerprint identifier for the file. A synchronising method can provide an additional feature, so that before an event of closing and deleting a file has been occurred, a step provides for examination of meta-data and examination of a fingerprint identifier for the open file; then a step can provide hashing of the currently open file to produce another hash value; then a step can provide comparison of the open file's hash value and the fingerprint identifier hash value. If the two hashes are different a step can enable encryption and saving of the changed, currently open file, saving the file as a new version of the open file and adding new meta-data information about the version of the file to the other recorded information. All this meta-data about files can be stored in a user's configuration data.

This concludes the detailed description of aspects of the disclosed invention. The preceding description of aspects of the disclosed invention is for illustration of some aspects of invention consistent with the inventor's broad inventive concepts, and the description is not intended to be exhaustive or to limit the inventor's inventive subject matter to the precise form disclosed. Various modifications and variations are possible consistent with the preceding disclosure and those modifications can also be realized by practical implementation of aspects of invention by a person of ordinary skill in the art. A person with ordinary skill in the art will note that the aspects of invention as described in this document can be implemented in many different modes of software and hardware consistent with the disclosed aspects of invention illustrated in the figures. Specific reference to hashing algorithms in the preceding description is also only for the purpose of illustrating some aspects of invention consistent with the inventor's broad inventive concepts. A person of ordinary skill in the art would be able to design additional software and hardware components to implement the aspects of invention that are derived from the description given above in a manner consistent with the inventor's broad inventive concepts. Generally, speaking as is known in industry, cryptographic processes are well suited to hardware implementation in form of circuitry and not merely software encoded on a non-transient computer readable medium.

### Hardware Implementation

Further modes of aspects of invention can be contemplated. AES-GCM has already been implemented in hardware format, including in particular, implementation in FPGA (field programmable gate array) format. Aspects of the present invention benefit from use of AES-GCM's AAD (Additional Authentication Data) as a check upon tampering as well as the AES's provision of state-of-the-art security. Accordingly, the inventor's concepts, which can include AES-GCM as elements of the inventor's combinations when rendered in apparatus and system format including methods, can be implemented, at least in part, in application specific circuitry.

### INDUSTRIAL APPLICABILITY

Cloud network services providers implementing solutions for businesses, individuals and government face many risks from hackers and other bad actors.

As a result of the enormity of data being transferred into and out of cloud-based networks every minute and the fact that a hacker can be a source of a particular data object coming into a network, cloud network services providers need to be able to immediately identify valid data and to launch appropriate responses against invalid data.

In systems using AES-GCM encryption, each encrypted data element has an associated IV as well as a related AAD value that is provided as input for the encrypted data element to be decrypted. In common practice, the IV is appended to the encrypted data element, typically by placing the bytes of the IV at the beginning of the encrypted data element before the encrypted data element is persisted in a data storage repository, where the expression “persisted” means that the encrypted data element is stored on a non-transient computer readable medium.

It has been explained above that in the systems, apparatus and methods disclosed in this document according to particular aspects of invention, that an unencrypted configuration data element [123] created by the systems/apparatus/methods, need not be a static unchanging object. Rather new content can be added to a user's configuration data over time. To give some examples, a new encryption key can be added to the unencrypted configuration data [123], or new meta-data information can be added about a specific file that has been encrypted with a specific key. Consequently, an unencrypted configuration data element can be an object that can be repeatedly updated and changed, and in this process of change, a new and different unencrypted configuration data element can be produced by the systems/apparatus/methods, according to aspects of invention, whenever any change is implemented.

In systems using AES encryption, if two different unencrypted configuration data elements are encrypted with the same AES key and IV then such a process can create security vulnerabilities, as is explained in the cited NIST document, see above, in the NIST section entitled “Importance of the Uniqueness Requirement on IVs”. Therefore, it is desirable that a particular IV should not be used more than once. Consequently, every version of an unencrypted configuration data element created according to aspects of the present invention can have a unique IV input, where the IV is a fresh IV.

Advantageously, in the disclosed systems/apparatus/methods, each IV can be constructed in such a way that information in the IV can provide information about a specific encryption key required for decryption of any encrypted data file which can include an encrypted configuration data element or any other encrypted file for that matter. A cloud network services provider needs to be able to immediately identify valid data received by a network. Accordingly, if in the first bytes of an incoming data element, the leading data includes the IV, then the IV can provide information to a services provider which can enable the services provider to validate the incoming data.

An IV, which can be ninety-six bits in length according to one aspect of invention, can be composed of two parts: a randomly generated nonce value that can provide uniqueness and an identifier value, being a signifier (configuration data identifier) associated with an Encrypted User Data Identifier. Given that the IV can be ninety-six bits or twelve bytes in length in some cases, the first four bytes can take a form that includes following numbers: “0001”, “0002” or “0003”, derived from an incrementing numeric sequence of numbers, this can provide the freshness required in an IV according to AES-GCM. Advantageously, the remaining part of the IV can include eight bytes of data that can be a segment of an Encrypted User Data Identifier that was previously defined in this document—see the above Definitions section. This Encrypted User Data Identifier can provide a value signifying a specific cipher key (Cipherkey) needed for decryption of encrypted user data.

A complete Encrypted User Data Identifier value can be a value of varying length, depending upon the specific hashing algorithm used to create the user's cipher key (Cipherkey). A SHA-384 hash value is a byte array of a length of forty-eight bytes, whereas a SHA-512 hash is a sixty-four bytes long. In any case, a portion included in the IV can be data with a length of just eight bytes in one example, and these eight bytes can be used to search and find information about a corresponding Encrypted User Data Identifier. A cloud services provider receiving an incoming encrypted data element can read the incoming eight bytes of data and then search for the details of a specific user of the system who is identifiable by that search. The cloud services provider can store information about each user, including information including the specific IP address of a specific user associated with a specific Encrypted User Data Identifier. On the basis of this information about a user associated with an Encrypted User Data Identifier, the services provider can check the source IP of an incoming data and determine if that IP is valid. Validating the incoming data in this way, the systems/apparatus/methods according to aspects of invention, can receive or reject incoming data.

An encrypted file as shown in FIG. 13 can contain a block of IV data [245] being an array of bytes containing information about a specific symmetric decryption key, as well as a nonce required for uniqueness of the IV. A cloud services provider storing encrypted configuration data objects can store a great number of configuration data files in a single location including in a bucket. Thousands of versions of a specific user's configuration data can be stored alongside each other.

Additionally, the encrypted configuration data file can be named using the full Encrypted User Data Identifier string together with the nonce value signifying the file version such as “0001” in one example. Thus, a file name can take in one instance the following form:

### Ir1_7qWqwVnDpsZhC5Jey13UTLTsY-C9-ePWspxhT6p-EhL00B6QgPmB_1bk9aMv. 0001

Using this method of sequential listing using nonces, a cloud network services provider has a practical method for storing many versions of a specific user's configuration data in a single data storage location. Additionally, the process of using nonces provides a mechanism for determining the most recent version of any user's configuration data, by employing a process in which the larger value of two numbers such as “0002” signifies a later version of a file rather than the smaller value “0001”.

Industrial applicability of aspects of the current invention can be demonstrated in an implementation involving use of Javascript code running in a web browser for displaying information to a user, for encrypting and decrypting, and for uploading and downloading data. In one aspect, the React Javascript library can provide a suitable instance of a technology for building web applications running in a browser that aspects of the current invention can be used with, for a purpose of providing additional security.

With reference to the FIGURES provided for detailing the functioning of aspects of the present invention, the disclosed methods and apparatus of aspects of the invention can be included within a React Javascript Application by adding an additional module to extend the application's functionality. There are a number of ways to do this; more generally, it can be said that the module, when included in the React Javascript Application as a whole, can provide additional APIs (application programming interfaces) to the set of available APIs initially provided by React itself.

With reference to FIG. 1, at the start [101] a user can launch a web browser running on a host computer system, navigating to a specific URL. In other words, a user can navigate to a specific web page address corresponding to a remote web site, being a location from where a web browser can download content for constructing a page of content visible by a user. The user can then see a web page presented to him/her by the browser. On this page the React Javascript Application can display a form into which a user can enter a password [103]. Receiving this password input, the React Javascript Application can use an API provided through inclusion of aspects of the invention in a Javascript module, and use three hashing algorithms to produce three hash values: Hash1 [163], Hash2 [165] and Hash3 [167] derived from the password [103].

In a first implementation, the Application can produce a random data object [115] that can be encrypted and decrypted using the Hash1 [163] value. The Hash2 [165] value provides a text string used for identifying an encrypted file containing the random data. The Application can now have, according to one aspect, all required elements of the Cipherkey Source Material (the random data object [115] and, optionally, the Hash1 [163] value), so in the next step [117] the Application can produce the final CipherKey [119]. Subsequently, this CipherKey [119] can be used to decrypt User Configuration Data [123] which can contain a diverse array of elements including stored encryption keys, password and personal information. Then finally, with the Application loading these elements the Application can then provide a set of cryptographic components to the user, enabling him/her to encrypt and decrypt files and messages, and to engage in encrypted communications.

Security of the procedure outlined in the first implementation above can be further enhanced in a number of ways. In a second implementation building upon the first, an encrypted random data file [137] can be stored on a detachable USB mounted device [135] as shown in FIG. 2. In a third implementation also building on the first, as shown in FIG. 3, an encrypted random data file [137] can be stored in a bucket [141] provided by a cloud hosting services provider connected to the user's computer system by a network [139].

In a fourth implementation, a detachable USB mounted device [135] as shown in FIG. 2, can contain a circuit providing cryptographic functions, such that the computing of the processes [117] and [123] for producing a Cipherkey [119] occur within the USB mounted device and not within the React Javascript Application running in the web browser on a host computer system. In this implementation, all the keys and cryptographic functions can reside within the USB mounted device, and the React Javascript Application can simply provide a presentation layer of the Application for displaying decrypted information to a user.

In a fifth implementation, building upon the industrial application of principles described in the fourth implementation, we can have a use case that does not involve using a web browser or Javascript at all: a detachable device [135] as shown in FIG. 2, an implementation of aspects of invention, containing a circuit providing cryptographic functions, can interface with applications written in Java (not Javascript), or Python or other languages, which can operate on a host computer system connected to a detachable device.

In a sixth implementation, the host computer system connected to the internet can be connected to a detachable device containing required cryptographic functions; this connection with the device being achieved not by a USB connection but by several other methods/apparatus that are possible, including Bluetooth or the WiGig wireless network protocol that can produce signals that cannot penetrate walls, with a result that an internet connected host computer within a room with thick walls, connected to a detachable device containing the required cryptographic functions, can use the provided system to encrypt and decrypt files and messages, and to engage in encrypted communications with people or web sites that are online. In this implementation, the host computer system can be used for two procedures only, the system can be provide a method of connecting to a network, and the system can provide a method of displaying decrypted data to a user via a monitor or sound system.

A seventh implementation builds upon the sixth. The host computer system connected to the internet, which is discussed in the sixth implementation, could provide a security risk, because encrypted data displayed on a device connected to a network and that device could be hacked by hackers. Consequently, another solution can be to have a detachable device providing cryptographic functions being connected to a screen, sound system or other peripheral devices that are totally disconnected from any network. In this case, the host computer system merely provides network connectivity and does not receive or display any unencrypted data.

1. A computer system including a user interface and a non-transient computer readable medium encoded with computer executable instructions that, when executed by a processor, construct an apparatus to manage methods of operation that produce a symmetric encryption key for encrypting and decrypting data, comprising:
a processor;
a memory coupled to the processor for storing data;
a non-transient computer readable medium coupled to the processor for storing a persistent data structure, this data structure containing a plurality of entries, each entry being identifiable by a signifier;
computer executable instructions stored as a plurality of entries in a persistent data structure in a computer readable non-transient medium;
a first, second and third one-way cryptographic hashing method, each of these three one-way cryptographic hashing functions being a different cryptographic function;
a fourth one-way cryptographic hashing method, identical with or different from either the first, second or third one-way cryptographic hashing functions;
an encryption method;
a decryption method;
a random number generating method;
a key generation method for producing symmetric and asymmetric encryption keys;
a user interface;
a processor executing an instruction to construct an apparatus;
an apparatus applying a method for receiving a secret input item provided to the computer system by a new user using a user interface;
an apparatus passing a secret input provided by a new user to methods of operation for producing new cryptographic key material;
an apparatus applying a key generation method to produce a plurality of new symmetric and asymmetric encryption keys;
an apparatus applying a method putting a plurality of new encryption keys in a computer system's memory;
an apparatus applying a method for generating a configuration data for a new user;
an apparatus applying a method putting a configuration data in a computer system's memory;
an apparatus applying a first cryptographic hashing method to a secret input item to produce a first hash value;
an apparatus applying a second and different cryptographic hashing method to a secret input item to produce a second hash value;
an apparatus applying a third and different cryptographic hashing method to a secret input item to produce a third hash value;
an apparatus applying a random number generating method to produce a large mass of pseudo-random bytes of data;
an apparatus encrypting a large mass of pseudo-random bytes with an encryption method using at least a part of the third hash value as the symmetric encryption key, to produce an encrypted random data;
an apparatus applying a method for transforming the second hash value into a text, then using at least a part of this text as a first file name signifier for identifying and storing data containing an encrypted random data;
an apparatus applying a method for creating an entry in a non-transient computer readable medium that contains an encrypted random data, this entry being identifiable by a first file name signifier;
an apparatus applying a method for joining a large mass of unencrypted pseudo-random bytes of data with a first hash value to produce a Cipherkey source material, then applying a fourth one-way cryptographic hashing method to hash a Cipherkey source material and generate a fourth hash value known as a Cipherkey;
an apparatus applying an encryption method to encrypt configuration data and a plurality of new encryption keys stored in memory to produce a private data, using at least a part of the fourth hash value (Cipherkey) as a symmetric encryption key;
an apparatus applying a fourth one-way cryptographic hashing method to hash a fourth hash value (Cipherkey) to produce a fifth hash value;
an apparatus applying a method for transforming the fifth hash value into a text, then using this text as a second file name signifier for identifying and storing data containing a private data comprised of encrypted configuration data and encrypted keys;
an apparatus applying a method for creating an entry in a non-transient computer readable medium that contains a private data, this entry being identifiable by a second file name signifier;
an apparatus providing methods to a user via a user interface, enabling a user to use cryptographic methods without limitation to encrypt, decrypt and store files and streams of data using a plurality of encryption keys and the information in a configuration data;
an apparatus providing methods to a user via a user interface, enabling a user to provide one or more inputs defining specific locations for storing encrypted files.

2. The computer system including a non-transient computer readable medium, apparatus and user interface in claim 1, further providing for:
an apparatus applying a method for receiving a secret input item provided by a returning user reconnecting to the computer system;
an apparatus passing a secret input provided by a returning user to methods of operation for reproducing cryptographic key material;
an apparatus applying a first cryptographic hashing method to a secret input item to produce a first hash value;
an apparatus applying a second and different cryptographic hashing method to a secret input item to produce a second hash value;
an apparatus applying a third and different cryptographic hashing method to a secret input item to produce a third hash value;
an apparatus applying a method for transforming the second hash value into a text, then using this text as a first file name signifier for identifying, requesting and receiving a securely stored data containing a large mass of encrypted pseudo-random bytes;
an apparatus applying a decryption method to decrypt data containing a large mass of pseudo-random bytes using at least a part of the third hash value as the symmetric decryption key, producing a decrypted random data object as the result;
an apparatus joining a decrypted random data object with a first hash value to produce Cipherkey source material, then applying a fourth one-way cryptographic hashing method to hash this Cipherkey source material to generate a fourth hash value known as a Cipherkey;
an apparatus applying a fourth one-way cryptographic hashing method to a fourth hash value (Cipherkey) to produce a fifth hash value;
an apparatus applying a method for transforming the fifth hash value into a text, then using this text as a second file name signifier for identifying, requesting and receiving a securely stored data containing a private data;
an apparatus applying a decryption method to decrypt a securely stored data identifiable by a second file name signifier using at least a part of the fourth hash value (Cipherkey) as the symmetric decryption key,
an apparatus providing a method for extracting information in a decrypted private data, this decrypted private information including configuration data and a plurality of encryption keys;
an apparatus putting extracted configuration data and a plurality of encryption keys in a computer system's memory;
an apparatus providing methods to a user via a user interface, enabling a user to use cryptographic methods without limitation to encrypt, decrypt and store files and streams of data using a plurality of encryption keys and the information in a configuration data extracted from an encrypted, stored private data.

3. The apparatus applying a method for providing user interface components for enabling a user to provide one or more inputs defining specific locations for storing encrypted files in claim 1, further providing for:
the apparatus receiving one or more inputs specifying one or more locations for storing encrypted files;
the apparatus applying a method for storing an encrypted random data in a specific location defined at least in part from a user input, this data containing a large mass of pseudo-random bytes;
the apparatus applying a method for storing an encrypted private data in a specific location defined at least in part from a user input, this data containing configuration data and encrypted keys;
the apparatus applying a method for reading and decrypting a random data stored in a specific location defined at least in part from a user input, this data containing a large mass of pseudo-random bytes;
the apparatus applying a method for reading and decrypting a private data stored in a specific location defined at least in part from a user input, this data containing configuration data and encrypted keys.

4. The apparatus and methods of the computer system including a non-transient computer readable medium in claim 1, further providing for:
the apparatus applying a method for sending information needed for authentication to a secure network, and for sending a file containing an encrypted random data for storage in a non-transient computer readable medium, this file being identifiable by a first file name signifier, with the file containing a large mass of encrypted pseudo-random bytes;
the apparatus applying a method for sending information needed for authentication to a secure network, and for sending a file containing an encrypted private data for storage in a non-transient computer readable medium, this file being identifiable by a second file name signifier, with the file containing a configuration data and encrypted keys associated with a user;
the apparatus applying a method for sending information needed for authentication to a network, together with a request to download a stored data, including a first file name signifier derived at least in part from a second hash value in the request, then receiving data containing a large mass of encrypted pseudo-random bytes;
the apparatus applying a method for sending information needed for authentication to a network, together with a request to download a stored data, including a second file name signifier derived at least in part from a fifth hash value in the request, then receiving data containing a configuration data and encrypted keys associated with a user;
applying a method for an administrator of a server and a secure network to manage, authenticate and store data received from a computer system of a user;
applying a method for an administrator of a server and a secure network to provide a plurality of inputs that define specific locations for storing encrypted files produced by the computer system of a user;
applying a method for an administrator of a server and a secure network to store a plurality of files containing encrypted random data file in specified locations in a non-transient computer readable medium on a network, said files being identifiable by at least a part of a first file name signifier;
applying a method for an administrator of a server and a secure network to store a file containing a private data in a specified location in a non-transient computer readable medium on a network, said file being identifiable by at least a part of a second file name signifier;
applying a method for an administrator of a server and a secure network to receive a request produced by the computer system of a user, this request containing a file name signifier used for identifying and reading the data of a securely stored file, then for sending the file to the computer system of a user as a response.

5. The apparatus and methods of the computer system including a non-transient computer readable medium in claim 1, wherein the apparatus applies an encryption method to encrypt configuration data and a plurality of new encryption keys stored in memory to produce a private data, using at least a part of the fourth hash value (Cipherkey) as a symmetric encryption key, further providing for:
the apparatus applying a method to produce not one file but a plurality of files containing private data, with said encrypted encryption keys being placed in a different file from an encrypted configuration data;
the apparatus applying a method for transforming the fifth hash value into a text, then using this text as a second file name signifier for identifying and storing a plurality of encrypted files in a persistent data structure;
the apparatus applying a method for storing a plurality of encrypted files in a key-value database, with the content of each encrypted file being stored as a value associated with a key derived at least in part from the second file name signifier;
the apparatus applying a method for storing a plurality of encrypted files in a directory in a persistent data structure, said directory being identifiable at least in part by a second file name signifier;
the apparatus applying a key generation method to produce additional collections of symmetric and asymmetric encryption keys that are encrypted with the fourth hash value (Cipherkey) then stored as additional files in a persistent data structure.
